(19) United States
(12) Patent Application Publication
(10) Pub. No.: US 2004/0180990 A1
(43) Pub. Date: Sep. 16, 2004

(54) Resin molded article

(75) Inventors: Fumiyuki Suzuki, Kanagawa (JP); Tadashi Mochizuki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/795,987

(22) Filed: Mar. 10, 2004

(30) Foreign Application Priority Data
Mar. 11, 2003 (JP) 2003-064532

(51) Int. Cl. C08K 3/40; C08K 9/00

(52) U.S. Cl. 523/216; 523/219; 524/494

(57) ABSTRACT

A resin molded article having excellent mechanical properties, heat resistance, light weight, thermoplasticity, and recyclability, which gives no adverse effects to the environment after its disposal is provided. The resin molded article is produced by molding and crystallizing a composition comprising a crystallizable, biodegradable plastic resin containing a polylactic acid as its main component, a glass fiber, and a hollow glass balloon which has been surface treated with a coupling agent. The article has a heat distortion temperature of at least 80° C. and a density of up to 1.2 g/cm³.

### BACKGROUND OF THE INVENTION

1. Technical Field

This invention relates to a resin molded article, and to be more specific, to an article molded from a polylactic acid resin. The resin molded article has various functions and performances required for a resin member or part as well as outstanding heat resistance which avoids distortion of the article when it is exposed to a high temperature atmosphere as in the case of the interior of an automobile in summer, also avoiding the adverse effects on the function or performance of the surrounding members or parts caused by such distortion. The resin molded article is also light in weight, capable of fully fulfilling the functions required, recyclable, and has no adverse effects on the environment after its disposal.

2. Background Art

Resin molded articles are nowadays used in various industrial products as a member or a part constituting such products. These articles have been molded into the desired shape by using various molding materials produced from a single resin material or by combining two or more resin materials depending on the required function, performance, and characteristics. For example, various resin molded articles are used as a member or a part of a container, casing, lid, spool, and the like for accommodation, packaging, covering, carrying, storage, shape maintenance, or the like of a recording material such as a photographic recording material, a magnetic recording material, or an optical recording material; and as a member of a cassette case and the like. Resin molded articles of various resin materials are also used as a member for accommodating the recording material itself, for example, as a cassette, a magazine, or a case of a one-time-use recyclable camera; as a case for merely protecting the recording material; as a case for accommodating an audio cassette tape, a video tape, or the like; and as a case for accommodating a CD, MD, or the like.

By the way, most of these resin molded articles are discarded after fulfilling their function, and they are recycled if recyclable. For example, various members and parts constituting the recording material as described above are separated and discarded before or during use of the recording material, or discarded together with the recording material upon its disposal.

Conventional resin molded articles, however, hardly decomposes in the natural environment they are discarded, and had become an environmental pollutant. On the other hand, disposal by incineration is associated with the risk of inviting environmental pollutants including dioxins.

In view of the situation as described above, use of molded articles produced by using a material degradable in natural environment has been recently discussed. One such material degradable in natural environment is a biodegradable plastic resin. For example, a mass scale, inexpensive production of polylactic acid resins has recently been enabled by using fermentation products of beet, maize, and other vegetables, fermentation products of garbage and other house wastes, and other readily available materials. This polylactic acid resin has attracted attention as a material which is recyclable, which is decomposable by the action of microorganisms in nature, which places no load on the environment, and which is environmentally friendly.

The polylactic acid resin, however, has a glass transition temperature as low as 58° C., and experiences considerable softening at a temperature in excess of 60° C. Accordingly, use of the polylactic acid resin has been difficult in applications requiring heat resistance due to the risk of becoming distorted when it is left in the environment where temperature reaches high, for example, on the dashboard of automobiles in summer. In view of such situation, JP 2001-329072A proposes a carbon fiber-reinforced composite material comprising a carbon fiber having a crystal size of 1.4 to 4.5 nm and the biodegradable plastic resin, and this material has been reported to have excellent mechanical properties as well as outstanding electroconductivity.

A method of injection foaming for producing a polylactic acid injection foamed article and an apparatus used therefor have also been proposed in JP 2002-79545A.

A biodegradable card using calcium carbonate, mica, calcium silicate, white carbon, asbestos, china clay (calcined), glass fiber, titanium oxide, or a mixture thereof for the filler of a polylactic acid resin has also been proposed in JP 2001-055498A.

The method of adding a reinforcement fiber, however, has been associated with the problem of an increased weight compared to the articles molded from an ordinary plastic resin when the reinforcement fiber used had a high specific weight.

### SUMMARY OF THE INVENTION

An object of the present invention is to obviate the problems associated with the prior art as described above, and provide a resin molded article comprising a crystallizable, biodegradable plastic resin containing a polylactic acid as its main component, which has excellent heat resistance and light weight, which is thermoplastic and recyclable, and which is associated with little risk of causing environmental problems when left in nature due to final decomposability by microorganisms.

This invention provides the following (1) and (2).

(1) A resin molded article produced by molding and crystallizing a composition comprising a crystallizable, biodegradable plastic resin containing a polylactic acid as its main component, a glass fiber, and a hollow glass balloon which has been surface treated with a coupling agent,

said molded article having a heat distortion temperature of at least 80° C. and a density of up to 1.2 g/cm³.

(2) A resin molded article according to the above (1) wherein the glass fiber comprise 5 to 30% by weight and said hollow glass balloon comprises 5 to 30% by weight of the total of the biodegradable plastic resin, the glass fiber, and the hollow glass balloon; the content in % by weight of the glass fiber is up to 1.9 folds of the content in % by weight of the hollow glass balloon; and total content of the glass fiber and the hollow glass balloon is up to 40% by weight of the total of the biodegradable plastic resin, the glass fiber, and the hollow glass balloon.

### DETAILED DESCRIPTION OF THE INVENTION

Next, the resin molded article of the present invention is described in further detail.

In the present invention, the term “resin molded article” is used to include various articles such as structural members constituting a functional material; a container, a lid, and other associated members used for accommodation, packaging, covering, carrying, storage, shape maintenance, and the like of a recording material; and a molded article for loading the functional material therein for realization of its function. Exemplary functional materials include photosensitive material, magnetic recording material, optical recording material, and other recording materials; pressure sensitive and heat sensitive recording materials; recording materials using a semiconductor memory; and the like. Exemplary recording materials include a negative film, a reversal film, a photographic paper, an instant photographic film of mono-sheet or peel apart type, and other photosensitive materials; audio cassette tape, video cassette tape, flexible disk, magnetic tape for recording computer data, and other magnetic recording materials; and CD, CD-R, CD-RW, DVD, DVD-R, DVD-RW, MD, and other optical recording materials.

Exemplary resin molded articles include, in the case of a photosensitive material, a spool, casing, container, lid, and the like of a negative or reversal film of 135, 110, 120, 220, or other specification; members constituting the case of an instant film pack (for example, members or parts constituting casing, light shielding sheet, resilient plate, flexible light-shielding sheet, light-shielding piece, bottom light-shielding sheet, and the like); casing and parts of internal mechanisms of a one-time-use recyclable camera; and other members and parts. In the case of a magnetic recording material, exemplary molded articles include a cassette casing and members constituting such casing for an audio cassette tape, a video cassette tape, a magnetic tape for recording computer data, and a flexible disk; and a case for accommodating such cassette. In the case of an optical recording material, exemplary molded articles include MD cassette, and cases for accommodating CD, CD-R, CD-RW, DVD, DVD-R, DVD-RW, MD, and the like.

The biodegradable plastic resin plastic resin of the present invention contains a polylactic acid as its main component. This polylactic acid may be a homopolymer of L-lactic acid, a copoylmer of L-lactic acid and D-lactic acid, a copolymer of L-lactic acid and a hydroxycarboxylic acid, or a mixture thereof. Examples of the hydroxycarboxylic acid include glycolic acid, 3-hydroxypropionic acid, 4-hydroxyvaleric acid, and 6-hydroxycaproic acid. Generally, only L-isomers are biodegradable in the case of a polylactic acid. Commercial scale production of the lactic acid homopolymer is carried out by producing lactic acid through lactic acid fermentation of starch which is a natural product, and then polymerizing the resulting lactic acid, and isomerization inevitably takes place in the course of such production. Accordingly, the lactic acid homopolymer contains a small amount of D-isomer as an impurity. In addition, an excessively low L-isomer purity inhibits crystallization of the polylactic acid, and therefore, the polylactic acid used in the present invention preferably has an L-isomer purity of at least 88%, preferably at least 95%, and most preferably 97 to 100%.

The polylactic acid may have a non-limited weight average molecular weight (Mw) or molecular weight distribution as long as the polylactic acid is substantially workable. Generally, the polylactic acid used in the present invention may preferably have a weight average molecular weight (Mw) of 10,000 to 500,000, more preferably 30,000 to 400,000, and most preferably 50,000 to 300,000 while the molecular weight of the polylactic acid is not particularly limited as long as the mechanical properties are at practically acceptable level. When the weight average molecular weight (Mw) is less than 10,000, the polylactic acid generally suffers from insufficient mechanical properties whereas the polylactic acid having a molecular weight in excess of 500,000 often suffers from handling inconvenience and economical disadvantage.

The biodegradable plastic resin of the present invention may also have blended therewith a biodegradable resin such as polybutylene succinate, polyethylene succinate, modified polyethylene terephthalate, polyhydroxy butylate, modified starch, and polycaprolactone in addition to the polylactic acid as described above to an extent that the crystallization of the polylactic acid is not inhibited by such blending.

The glass fiber used may be a commercially available chopped strand or robing. The glass fiber may have a fiber diameter of 1 to 30 μm, and more preferably 3 to 20 μm. Use of the glass fiber with a diameter of less than 3 μm is not practical since production of such thin fiber is difficult, and use of the glass fiber having a diameter in excess of 20 μm results in the poor appearance of the resulting product. When a chopped strand is employed, the strand may preferably have a fiber length of 1 to 10 mm in view of the handling convenience although the fiber length is not limited to such length. In the present invention, the glass fiber may be surface treated with a surface treating agent such as an aminosilane, which may be a monoaminosilane, a diaminosilane, or a triaminosilane, and preferably, a monoaminosilane or a diaminosilane. Exemplary surface treating agents include N-β-(aminoethyl)-γ-aminopropyltrimethoxysilane, N-β-(aminoethyl)-γ-aminopropylmethyldimethoxysilane, and γ-aminopropyltriethoxysilane. A sizing agent such as an epoxy resin or vinyl acetate may also be used.

The glass fiber is incorporated at an amount of 5 to 30% by weight of the total amount of the biodegradable plastic resin, the glass fiber, and the hollow glass balloon. When the glass fiber is used in such range, heat resistance can be improved without compromising the resin properties. More preferably, the glass fiber is used at an amount of 5 to 20% by weight.

The inventors of the present invention have found that a molded article produced by reinforcing a biodegradable plastic resin containing a polylactic acid as its main component with a glass fiber, and crystallizing the resin has excellent heat resistance, and described such article in Japanese Patent Application No. 2001-317053. A glass fiber is a fiber reinforcing material which has well balanced cost and performance. It is only after the simultaneous use of such glass fiber with the hollow balloon that the molded article of the present invention has realized its heat resistance, mechanical properties, and light weight.

The hollow glass balloon used in the present invention is a hollow glass microballoon or a hollow glass microsphere, and a commercially available product may be used in the present invention. The hollow glass balloon may have an average particle density of 0.2 to 1.0 g/cc, and preferably 0.3 to 0.8 g/cc. The average density in excess of 1.0 g/cc is not effective in reducing the weight of the product, and the average density of less than 0.2 g/cc leads to an insufficient compressive strength resulting in the damage of balloons in the course of kneading and injection molding. The hollow glass balloon of used in the present invention is preliminarily treated with a coupling agent. The hollow glass balloon that has been treated with a coupling agent can be uniformly mixed with the matrix resin and such balloon also exhibits good adhesion to the matrix resin, and the resulting resin molded product enjoys high impact strength.

Exemplary preferable coupling agents include silane coupling agents such as γ-(2-aminoethyl)aminopropyl-trimethoxysilane, γ-glycidoxypropyltrimethylsilane, γ-mercaptopropyltrimethoxysilane, methyltrimethoxysilane, γ-anilinopropyltrimethoxysilane, γ-ureidopropyltriethoxy-silane, and vinylacetoxysilane; titanate coupling agents such as isopropyltris(isostearoyl)titanate, isopropyl-tris(dioctylpyrophosphate)titanate, isopropyltris(N-aminoethyl-aminoethyl)titanate, tetraoctylbis(tridecyl-phosphite)titanate, bis(dioctylpyrophosphate)ethylene titanate, isopropyltridecylbenzenesulfonyl titanate, and isopropyltris(dioctylphosphate)titanate; aluminum coupling agents such as acetoalkoxyaluminum diisopropylate; and zircoaluminate coupling agents.

The hollow glass balloon is preferably added at an amount of 5 to 30% by weight of the total amount of the biodegradable plastic resin, the glass fiber, and the hollow glass balloon. If the hollow glass balloon is used within such an amount, weight of the resulting product can be reduced without detracting from the heat resistance. More preferably, the hollow glass balloon is used at an amount of 5 to 20% by weight.

The glass fiber is preferably used in % by weight at an amount of up to 1.9 folds, and more preferably at an amount of up to 1.5 folds of the hollow glass balloon. The amount of the glass fiber in % by weight is preferably equal to or smaller than the amount of the hollow glass balloon in % by weight. When these components are used at such ratio, the resulting resin molded article will have a reduced weight without detracting from the heat resistance or the mechanical properties. The glass fiber and the hollow glass balloon are preferably incorporated at a total amount of up to 40% by weight of the total amount of the biodegradable plastic resin, the glass fiber, and the hollow glass balloon. Use of the glass fiber and the hollow glass balloon at a total amount in excess of 40% by weight is not preferable since the resulting molded article suffers from poor impact strength.

In addition to the critical components as described above, the molded article of the present invention may have blended therewith a fiber reinforcement, a nucleating agent, a light shielding filler such as carbon black, a filler such as talk and mica, a lubricant such as silicone oil, a colorant such as pigment, an antioxidant, an antibacterial agent, a fungicide, a foaming agent, a UV absorber, a flame retardant, an antistatic agent, a plasticizer, or the like to the extent not compromising the merits of the present invention. Examples of the nucleating agent include inorganic nucleating agents such as talk, kaolin, kaolinite, kaolin clay, barium sulfate, silica, calcium lactate, and sodium benzoate as well as organic nucleating agents.

The method used in the present invention for the molding and crystallization is not particularly limited, and any of molding methods normally used for a thermoplastic resin can be employed. Exemplary such methods include single and double screw extrusion, blow molding, injection molding, sheet forming, thermoforming, rotational molding, and laminate molding, and the preferred is injection molding. The steps of drying, pelletization, annealing, and the like may also be incorporated. Of course, the molded article of the present invention may be subjected to a further treatment such as coating and plating as long as the merits of the present invention are not impaired.

Since the molded article of the present invention contains the glass fiber and the glass balloon, it enjoys outstanding heat resistance, and has overcome the problem of increase in the specific weight that had normally associated with the improvement in the heat resistance. Weight reduction with no compromise in the heat resistance is thereby enabled. Accordingly, the molded article of the present invention has a heat distortion temperature after molding of at least 80° and a density of up to 1.2 g/cm³, and preferably, a heat distortion temperature of at least 90° C. and a density of up to 1.1 g/cm³.

### EXAMPLES

### Example 1

i) Conditions for drying the polylactic acid: Drying in a vacuum dryer at 90° C. for 8 hours.

ii) Surface treatment of hollow glass balloon: To 400 parts by weight of distilled water was added a small amount of acetic acid to adjust pH to about 4, and 1 part by weight of silane coupling agent KBM402 manufactured by Shin-Etsu Chemical Co., Ltd. was then added and the mixture was stirred. To the mixture was added 20 parts by weight of hollow glass balloon (glass bubbles S60/1800 manufactured by Sumitomo 3M), and after stirring for 30 minutes, the mixture was filtered and dried at 120° C.

To the dried polylactic acid pellets (Lacty 9020 manufactured by Shimadzu Corporation) were added glass fiber (CS3PE941) and the surface treated hollow glass balloons at the amounts indicated in Table 1, and the mixture was kneaded and pelletized in a single screw extruder to produce polylactic acid pellets containing the glass fiber and the hollow glass spheres. These pellets were dried again under the same conditions as described above, and fed to an injection molding machine to produce the sample of the molded article. The injection molding was conducted at the maximum pressure of 50 MPa and the filling pressure was maintained at 60 MPa. The samples shown in Table 1 were produced in a similar manner. The samples were evaluated, and the results are shown in Table 1.

### Comparative Examples 1 to 2

The procedure of Example 1 was repeated to produce the resin molded articles. In the Comparative Examples, the articles, however, were produced without using the hollow glass balloon, or by using a hollow glass balloon which had not been surface treated. The resin molded articles were evaluated for their properties, and the results are shown in Table 1.

Evaluation was conducted by the measurements as described below.

1) Impact strength: Izod impact strength was measured in accordance with JISK-7110(ISO 180).

2) Specific weight: Density was measured in accordance with JISK-7112(ISO 1183).

3) Heat distortion temperature: Measurement was carried out in accordance with JISK-7191-1(ISO 75-1) by applying a load of 18.5 kg.

TABLE 1

| | | Hollow | | Heat | | |
|---|---|---|---|---|---|---|
| | | glass | Speci- | distor- | | |
| | Glass | parti- | fic | tion | Impact | |
| | fiber | cle | weight | temp. | strength | |
| | (wt %) | (wt %) | (g/cm³) | (° C.) | (J/m²) | Note |
| Ex. 1- | 7.5 | 7.5 | 1.19 | 132 | 15 | |
| 1 | | | | | | |
| Ex. 1- | 7.5 | 15 | 1.10 | 132 | 14 | |
| 2 | | | | | | |
| Ex. 1- | 15 | 15 | 1.15 | 142 | 13 | |
| 3 | | | | | | |
| Comp. | 7.5 | 0 | 1.25 | 125 | 21 | |
| Ex. 1- | | | | | | |
| 1 | | | | | | |
| Comp. | 15 | 0 | 1.31 | 151 | 26 | |
| Ex. 1- | | | | | | |
| 2 | | | | | | |
| Comp. | 15 | 7.5 | 1.20 | 141 | 11 | No |
| Ex. 2- | | | | | | surface |
| 1 | | | | | | treat- |
| | | | | | | ment |
| Comp. | 15 | 15 | 1.15 | 142 | 10 | No |
| Ex. 2- | | | | | | surface |
| 2 | | | | | | treat- |
| | | | | | | ment |

This invention provides a resin molded article with an outstanding heat resistance. The molded article does not experience distortion even when it is exposed to the high temperature atmosphere as in the case of the interior of an automobile in summer. The resin molded article also has high mechanical strength, light weight, thermoplasticity, recyclability. This molded article gives no adverse effects on the environment after its disposal.

What is claimed is:

1. A resin molded article produced by molding and crystallizing a composition comprising a crystallizable, biodegradable plastic resin containing a polylactic acid as its main component, a glass fiber, and a hollow glass balloon which has been surface treated with a coupling agent,
said molded article having a heat distortion temperature of at least 80° C. and a density of up to 1.2 g/cm³.

2. A resin molded article according to claim 1 wherein the glass fiber comprises 5 to 30% by weight and said hollow glass balloon comprises 5 to 30% by weight of the total of the biodegradable plastic resin, the glass fiber, and the hollow glass balloon; the content in % by weight of the glass fiber is up to 1.9 folds of the content in % by weight of the hollow glass balloon; and total content of the glass fiber and the hollow glass balloon is up to 40% by weight of the total of the biodegradable plastic resin, the glass fiber, and the hollow glass balloon.
